(19) United States
(12) Patent Application Publication
(10) Pub. No.: US 2025/0337204 A1
(43) Pub. Date: Oct. 30, 2025

(54) HIGH POWER DIRECT-CURRENT CHARGING PLUG CONNECTOR

(71) Applicant: ACES ELECTRONICS CO., LTD., Taoyuan City (TW)

(72) Inventors: Rong-Hsun KUO, Taoyuan City (TW); Kuei-Ta HSIEH, Taoyuan City (TW)

(21) Appl. No.: 19/030,196

(22) Filed: Jan. 17, 2025

(30) Foreign Application Priority Data
Apr. 25, 2024 (TW) 113115595

(51) Int. Cl. H01R 24/64; H01R 13/405; H01R 13/518; H01R 24/28

(52) U.S. Cl. CPC H01R 24/64; H01R 13/405; H01R 13/518; H01R 24/28

(57) ABSTRACT

A high power direct-current charging plug connector has an insulation base and two electrode boards. Each electrode board has an elongated plate portion, a ring, and a solder pad. The electrode plate portions are deposed laterally in an insertion recess of the insulation base. The solder pads extend out of a rear end of the insulation base. The rings are secured longitudinally on the insulation base from an inner side to an outer side and are connected with the corresponding elongated plate portions and the solder pads. Accordingly, the size of the electrode board can be as large as possible with small connector size standards to increase the withstand current value to 20A and to meet the expected charging requirement of 65W to 400W so as to improve the structural strength of the plug connection.

### CROSS-REFERENCE TO RELATED APPLICATIONS

This application is based upon and claims priority under 35 U.S.C. 119 from Taiwan Patent Application No. 113115595 filed on Apr. 25, 2024, which is hereby specifically incorporated herein by this reference thereto.

### BACKGROUND OF THE INVENTION

### 1. Field of the Invention

The present invention relates to a charging plug connector, and more particularly to a high power direct-current plug connector.

### 2. Description of the Prior Arts

With the trend of thin and light design of electronic products, a size of a direct-current (DC) charging connector applied for an electronic product has been reduced. Because the electronic product is frequently used and has high power consumption, great charging is required to meet the demand for rapidly charging.

Therefore, the following table shows a table of summary of power supply options for a small sized USB DC charging connector. The conventional maximum current is only up to 5 A (amperes), so further improvement is necessary.

| Mode of | Nominal | Maximum | | |
|---|---|---|---|---|
| Operation | Voltage | Current | | Notes |
| USB 2.0 | 5 V | 500 | mA | Default current, based |
| USB 3.1 | 5 V | 900 | mA | on definitions in the |
| | | | | based specification |
| USB BC 1.2 | 5 V | Up to 1.5 A | | Lengacy charging |
| USB Type-C | 5 V | 1.5 | A | Supports higher power |
| Current @ | | | | devices |
| 1.5 A | | | | |
| USB Type-C | 5 V | 3 | A | Supports higher power |

| | | | |
|---|---|---|---|
| Current @ | | | devices |
| 3.0 A | | | |
| USB PD | Configurable | Configurable | Directional control and |
| | up to 20 V | up to 5 A | power level management |

To overcome the shortcomings, the present invention provides a high power DC charging plug connector to mitigate or to obviate the aforementioned problems.

### SUMMARY

An objective of the present invention is to provide a high power DC charging plug connector.

The high power DC charging plug connector having:
an insulation base having an insertion recess;
a first electrode board having at least one first elongated plate portion, a first ring, and a first solder portion integrally formed from a front end to a rear end of the first electrode board, wherein the at least one first elongated plate portion is disposed laterally in the insertion recess, the first ring is longitudinally mounted on the insulation base, and the first solder pad is exposed from the insertion recess; and
a second electrode board having at least one second elongated plate portion, a second ring, and a second solder pad integrally formed from a front end to a rear end of the second electrode board, wherein the at least one second elongated plate portion is disposed laterally in the insertion recess, the second ring is longitudinally mounted on the insulation base and is arranged around and spaced from the first ring, and the second solder pad is exposed from the insertion recess.

Based on the foregoing description, the high power DC charging plug connector in accordance with the present invention has a ring disposed around the insulation base and integrally formed with electrode boards and solder pads. Thus, the size of the electrode board can be as large as possible with small connector size standards to increase the maximum current to 20 A and to meet the expected charging requirement of 65 W to 400 W. Furthermore, because the first ring of the first electrode board and the second ring of the second electrode board are arranged concentrically and secured on the base body of the insulation base, the structural strength of the plug connection can be improved.

### BRIEF DESCRIPTION OF THE DRAWINGS

FIG. 1 is a perspective view of a first embodiment of a high power DC charging plug connector in accordance with the present invention;

FIG. 2 is a partially exploded perspective view of the high power DC charging plug connector in FIG. 1;

FIG. 3 is a cross sectional front view of the high power DC charging plug connector in FIG. 1;

FIG. 4 is another cross sectional front view of the high power DC charging connected with a plug connector 1;

FIG. 5 is a perspective view of a second embodiment of a high power DC charging plug connector in accordance with the present invention;

FIG. 6 is a partially exploded perspective view of the high power DC charging plug connector in FIG. 5;

FIG. 7 is a partial perspective view of the high power DC charging plug connector in FIGS. 5; and

FIG. 8 is a cross sectional front view of the high power DC charging plug connector in FIG. 7.

### DETAILED DESCRIPTION OF THE EMBODIMENTS

The present invention is related to an improved charging connector. Other objectives, advantages and novel features of the invention will become more apparent from the following detailed description when taken in conjunction with the accompanying drawings.

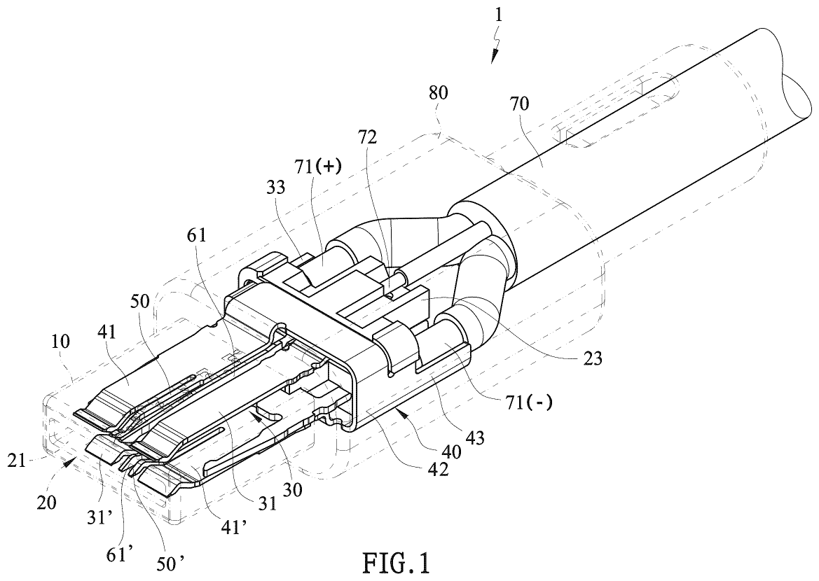

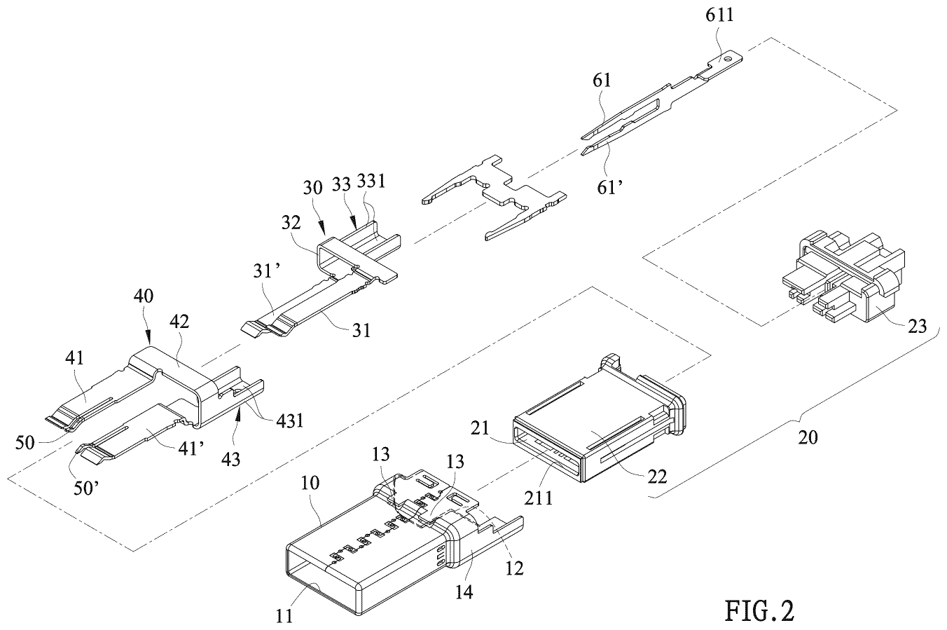

With reference to FIGS. 1 and 2, a first embodiment of a high power direct-current (DC) charging plug connector 1 in accordance with the present invention comprises a metal housing 10, an insulation base 20, a first electrode board 30, and a second electrode board 40. In an embodiment, the first electrode board 30 is a positive board, and the second electrode board 40 may be a negative board.

The metal housing 10 has a front opening 11 and a rear opening 12.

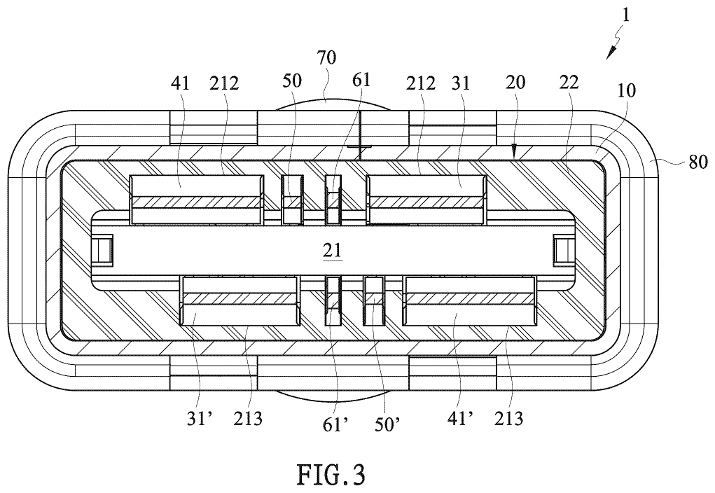

With reference to FIG. 3, the insulation base 20 is mounted in the metal housing 10 and has an insertion recess 21 having a first recess wall 212 and a second recess wall 213 facing each other. In this embodiment, the insulation base 20 has a base body 23 and an insertion casing 22. The insertion casing 22 is mounted in the metal housing 10, and the insertion recess 21 with the first recess wall 212 and the second recess wall 213 is defined in the insertion casing 22. A mouth 211 of the insertion recess 21 communicates with the front opening 11 in the metal housing 10. The base body 23 is located behind the insertion casing 22 and is held in the rear opening 12 of the metal housing 10.

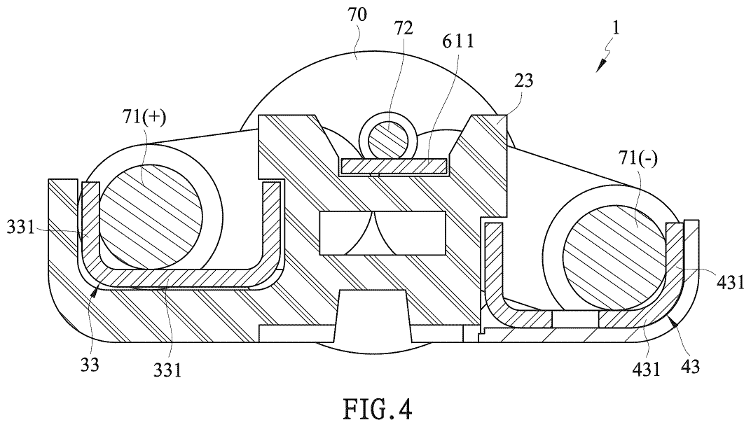

The first electrode board 30 has at least one first elongated plate portion 31, a first ring 32, and a first solder pad 33 integrally formed from a front end to a rear end of the first electrode board 30. The at least one first elongated plate portion 31 is held laterally in the insertion recess 21. The first ring 32 is mounted longitudinally in the base body 23 of the insulation base 20. The first solder pad 33 is exposed out of the insertion recess 21, extends through the base body 23, and extends out of a rear end of the base body 23. In this embodiment, the first electrode board 30 has two first elongated plate portions 31,31′. The two first elongated plate portions 31, 31′ are alternatively arranged up and down and are respectively adjacent to the first recess wall 212 and the second recess wall 213. The first ring 32 may be a half ring or a whole ring. The first solder pad 33 may further comprise at least two solder faces 331 and may be L-shaped or U-shaped as shown in FIG. 4.

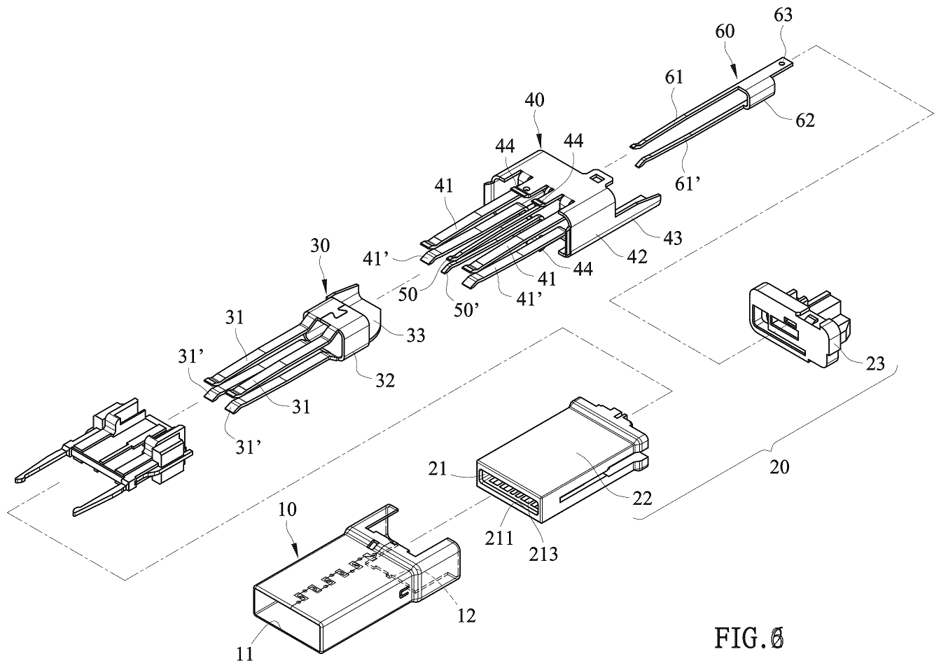

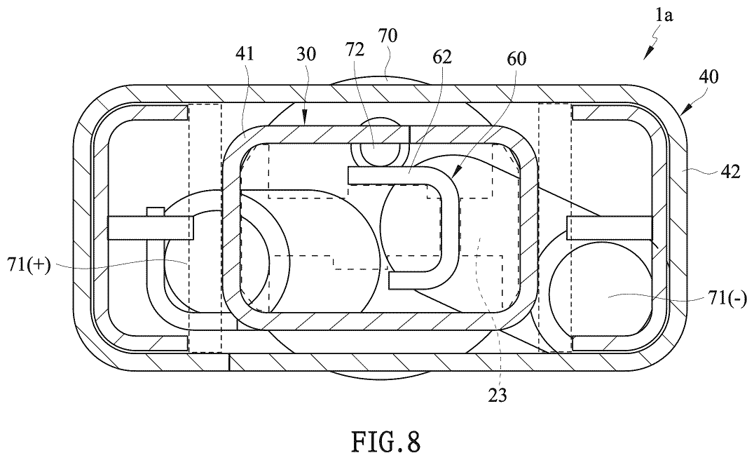

The second electrode board 40 has at least one second elongated plate portion 41, a second ring 42, and a second solder pad 43 integrally formed from a front end to a rear end of the second electrode board 40. The at least one second elongated plate 41 is disposed laterally in the insertion recess 21. The second ring 42 is secured longitudinally on the insulation base 20 and is located around and spaced from the first ring 32. Preferably, the second ring 42 is located around the based body 23 and is directly in contact with a rear portion 14 of the metal housing 10. The second solder pad 43 is exposed from the insertion recess 21, extends through the base body 23 and protrudes out of the rear end of the base body 23. In this embodiment, the second electrode board 40 includes two second elongated plate portions 41, 41′. The two second elongated plate portions 41, 41′ are alternatively arranged up and down and are respectively adjacent to the first recess wall 212 and the second recess wall 213. The second elongated plate portion 41 adjacent to the first recess wall 212 corresponds to the first elongated portion 31′ adjacent to the second recess wall 213 in position. The second elongated plate portion 41′ adjacent to the second recess wall 213 corresponds to the first elongated portion 31 adjacent to the first recess wall 212 in position. The first ring 32 and the second ring 42 may be a half ring as shown in FIG. 2 or a whole ring as shown in FIGS. 6 and 8. Preferably, the first ring 32 and the second ring 34 are arranged concentrically or are concentrically arranged with the metal housing 10. Each of the first ring 32 and the second ring 42 may be half ring or a whole ring. When the first ring 32 and the second ring 42 are all half ring as shown in FIG. 2, the notches of the first ring 32 and the second ring 42 are arranged alternatively or arranged in a same direction. Each of the first ring 32 and the second ring 42 may be a whole ring composed of two half rings. The second solder pad 43 may further comprise at least two solder faces 431 and may be L-shaped or U-shaped as shown in FIG. 4. In an embodiment, two first signal terminals 50, 50′ are mounted side by side on a middle portion of the insulation base 20 between the two second elongated plate portions 41, 41′. Each first signal terminal 50,50′ has a rear end integrally formed on a corresponding one of the second elongated plate portions 41, 41′.

In one embodiment, the first electrode board 30 has only single one first elongated plate portion 31, and the second electrode board 40 has only single one second elongated plate portion 41. The first elongated plate portion 31 and the second elongated plate portion 41 are arranged side by side and are adjacent to the first recess wall 212 or the second recess wall 213.

With reference to FIGS. 1 to 3, the DC charging plug connector 1 further comprises at lest one second signal terminal 61 disposed laterally in the insertion recess 21, secured in the based body 23 of the insulation base 20, and protruding out of the rear end of the base body 23. The second signal terminal is located between the first elongated plate portion 31 and the second elongated plate portion 41. In this embodiment, the DC charging plug connector 1 includes two second signal terminals 61, 61′ disposed laterally in the insertion recess 21 and secured in the based body 23 of the insulation base 20. One of the second signal terminals 61 is located adjacent to the first elongated plate portion 31 and the second elongated plate portion 41 on the first recess wall 212, and the other one second signal terminal 61′ is located adjacent to the first elongated plate portion 31′ and the second elongated plate portion 41′ on the second recess wall 213. In an embodiment, portions of the two second signal terminals 61, 61′ secured on the base body 23 are integrally connected with each other to form as a tuning fork-shaped. A flat solder pad 611 is formed on the two second signal terminals 61,61′ and extends out of the rear end of the base body 23.

With reference to FIGS. 1 and 4, in this embodiment, the DC charging plug connector 1 is further soldered with a charging wire 70. Multiple metal wires 71 and/or signal metal wires 72 are exposed from a front end of the charging wire 70. The metal wires 71 are soldered respectively with the first solder pad 33 and the second solder pad 43 exposed from the rear end of the base body 23. The signal metal wire 72 is soldered with the plate solder pad 611.

In addition, with reference to FIGS. 1 and 2, the DC charging plug connector in accordance with the present invention further comprises an outer rubber body 80 coated around a connection between the metal housing 10 and the charging wire 70. Multiple ribs 13 are formed on the metal housing 10 at positions coated by the outer rubber body 80 and extend into the outer rubber body 80 to prevent a gap from being formed between the metal housing 10 and the outer rubber body 80 while the plug connector is unplugged.

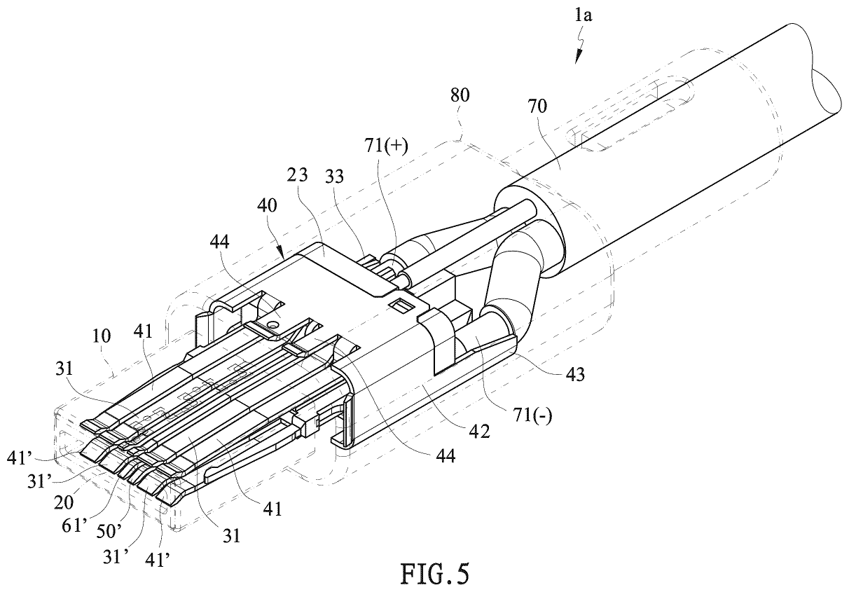

With reference to FIGS. 5 and 6, a second embodiment of a high power DC plug connector 1a in accordance with the present invention is shown and has a structure substantially the same as that of the first embodiment except that a first electrode board 30 includes four first elongated plate portions 31, 31′, and a second electrode board 40 includes four second elongated plate portions 41, 41′.

Two of the first elongated plate portions 31 of the first electrode board 30 are arranged side by side and are adjacent to the first recess wall 212. The other two of the first elongated plate portions 31′ are arranged side by side and are adjacent to the second recess wall 213 and correspond respectively to the first elongated plate portion 31 adjacent to the first recess wall 212, as the positions of the first and second recess walls 212, 213 in FIG. 3.

Two of the second elongated plate portions 41 of the second electrode board 40 are arranged side by side and are adjacent to the first recess wall 212, and the first elongated plate portions 31 adjacent to the first recess wall 212 are located between the two second elongated plate portions 41 adjacent to the first recess wall 212. The other two of the second elongated plate portions 41′ correspond respectively to the two of the second elongated plate portions 41 adjacent to the first recess wall 212 in position, are arranged side by side and are adjacent to the second recess wall 213, and the first elongated plate portions 31′ adjacent to the second recess wall 213 are located between the two second elongated plate portions 41′ adjacent to the second recess wall 213. In an embodiment, the DC charging plug connector la in accordance with the present invention further comprises two first signal terminals 50, 50′ integrally formed on the second ring 42 and being respectively adjacent to the first recess wall 212 and the second recess wall 213. The first signal terminal 50 adjacent to the first recess wall 212 is located between the two first elongated plate portions 31 adjacent to the first recess wall 212. The first signal terminal 50′ adjacent to the second recess wall 213 is located between the two first elongated plate portions 31′ adjacent to the second recess wall 213.

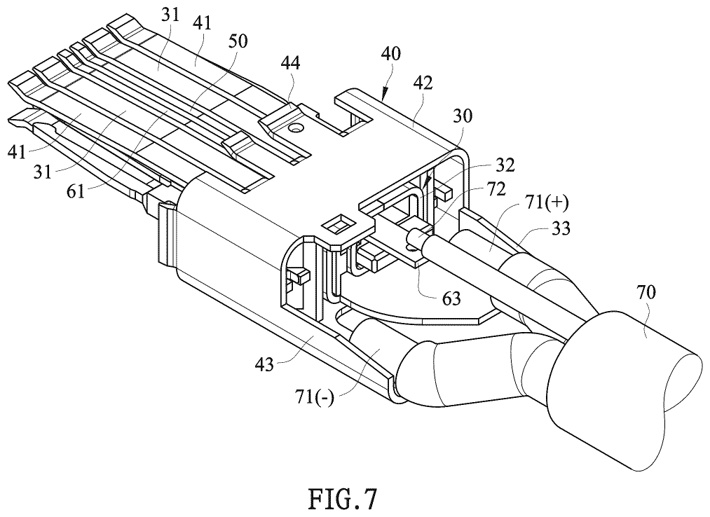

In another embodiment, the DC charging plug connector 1a in accordance with the present invention further comprises a signal board 60 having two second signal terminals 61, 61′, a third ring 62, and a third solder pad 63 integrally formed from a front end to a rear end of the signal board 60. The two second signal terminals 61,61′ are disposed laterally in the insertion recess 21 and are adjacent respectively to the first recess wall 212 and the second recess wall 213. The second signal terminal 61 adjacent to the first recess wall 212 is located between the two first elongated plate portions 31 adjacent to the first recess wall 212. The second signal terminal 61′ adjacent to the second recess wall 213 is located between the two first elongated plate portions 31′ adjacent to the second recess wall 213. The third ring 62 is secured longitudinally in the base body 23 of the insulation base 20. Preferably, with reference to FIGS. 1, 7, and 8, the third ring 63 and the first ring 32 are arranged in the base body 23 of the insulation 20 from an inner side to an outer side. The second ring 42 is mounted around the base body 23. Thus, the first ring 32, the second ring 42, and the third ring 62 are arranged concentrically. The second ring 42 has a size larger than a size of the first ring 32, and the size of the first ring 32 is larger than a size of the third ring 62. But the size relations between the rings 32,42,62 are not limited to the aforementioned. The third solder pad 63 is exposed from the insertion recess 21 and protrudes out of the rear end of the base body 23 of the insulation base 20.

In this embodiment, the rear portion 14 of the metal housing 10 is located between the base body 23 and the second ring 42 and is directly in contact with the second ring 42. Accordingly, an outer rubber body 80 is coated around the rear portion 14 of the metal housing 10 and a connection between the second ring 42 and the charging wire 70. Multiple ribs 44 protrude forward from the second ring 42 and extend into the outer rubber body 80.

Based on the foregoing description, the high power DC charging plug connector in accordance with the present invention has a ring disposed around the insulation base and integrally formed on electrode boards and solder pads. Thus, the size of the electrode board can be as large as possible with small connector size standards to increase the withstand current value to 20A and to meet the expected charging requirement of 65 W to 400 W. Furthermore, because the first ring of the first electrode board and the second ring of the second electrode board are arranged concentrically and are secured on the base body of the insulation base, the structural strength of the plug connection can be improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A high power direct-current charging plug connector comprising
an insulation base having an insertion recess;
a first electrode board having at least one first elongated plate portion, a first ring, and a first solder pad integrally formed from a front end to a rear end of the first electrode board, wherein the at least one first elongated plate portion is disposed laterally in the insertion recess, the first ring is longitudinally mounted on the insulation base, and the first solder pad is exposed from the insertion recess; and
a second electrode board having at least one second elongated plate portion, a second ring, and a second solder pad integrally formed from a front end to a rear end of the second electrode board, wherein the at least one second elongated plate portion is disposed laterally in the insertion recess, the second ring is longitudinally mounted on the insulation base and is arranged around and spaced from the first ring, and the second solder pad is exposed from the insertion recess.

2. The plug connector as claimed in claim 1, wherein the first ring and the second ring are arranged concentrically.

3. The plug connector as claimed in claim 2, wherein each of the first ring and the second ring is half ring-shaped.

4. The plug connector as claimed in claim 3, wherein a notch of the first ring and a notch of the second ring face a same direction or are arranged alternatively.

5. The plug connector as claimed in claim 2, wherein each of the first ring and the second ring is whole ring-shaped or composed of two half rings.

6. The plug connector as claimed in claim 2, wherein each of the first solder pad and the second solder pad has at least two solder faces.

7. The plug connector as claimed in claim 6, wherein
the insulation base has a first recess wall and a second recess wall facing each other;
the first electrode board has a single one first elongated plate portion; and
the second electrode board has a single one second elongated plate portion, and the first elongated plate portion and the second elongated plate portion are adjacent to the first recess wall.

8. The plug connector as claimed in claim 6, wherein
the insulation base has a first recess wall and a second recess wall facing each other;
the first electrode board has two first elongated plate portions arranged alternatively and being respectively adjacent to the first recess wall and the second recess wall; and
the second electrode board has two second elongated plate portions arranged alternatively and being respectively adjacent to the first recess wall and the second recess wall, wherein the second elongated plate portion adjacent to the first recess wall corresponds to the first elongated plate portion adjacent to the second recess wall in position, and the second elongated plate portion adjacent to the second recess wall corresponds to the first elongated plate portion adjacent to the first recess wall in position.

9. The plug connector as claimed in claim 8, wherein two first signal terminals are mounted on a middle portion of the insulation base and located between the two second elongated plate portions, and each first signal terminal has a rear end integrally formed on a corresponding one of the second elongated plate portions.

10. The plug connector as claimed in claim 7 further comprising a signal terminal secured in the insulation base, disposed laterally in the insertion recess, and located between the first elongated plate portion and the second elongated portion, and the signal terminal has a rear end extend out of a rear end of the insulation base.

11. The plug connector as claimed in claim 8 further comprising two signal terminals secured in the insulation base, disposed laterally in the insertion recess, and located respectively between the first elongated plate portion adjacent to the first recess wall and the second elongated portion adjacent to the first recess wall and between the first elongated plate portion adjacent to the second recess wall and the second elongated portion adjacent to the second recess wall.

12. The plug connector as claimed in claim 11, wherein portions of the two signal terminals secured in the insulation base are connected integrally with each other, extend out of a rear end of the insulation, and are formed as a tuning fork-shaped.

13. The plug connector as claimed in claim 11, wherein the insulation base comprises
a base body in which the first ring is mounted and around which the second ring is mounted; and
an insertion casing being located in front of the base body, and the insertion recess defined in the insertion casing.

14. The plug connector as claimed in claim 13 further comprising a metal housing having a front opening and a rear opening, wherein the front opening communicates with the insertion recess in the insertion casing, and the base body is held in the rear opening that has a wall being directly in contact with the second ring, wherein the first solder pad and the second solder pad extend out of the rear end of the insulation base, and are soldered respectively with metal electrode wires of a charging wire, and the two signal terminal are integrally connected with each other, extend out of the rear end of the insulation base, and is soldered with a metal signal wire of the charging wire.

15. The plug connector as claimed in claim 14 further comprising an outer rubber body coated around a connection between the metal housing and the charging wire, wherein multiple ribs protrude forward from the metal housing and extend into the outer rubber body.

16. The plug connector as claimed in claim 6, wherein
the insulation base has a first recess wall and a second recess wall facing each other;
the first electrode board has four first elongated plate portions, wherein two of the four first elongated plate portions are arranged side by side and are adjacent to the first recess wall, and the other two of the four first elongated plate portions are arranged side by side and are adjacent to the second recess wall; and
the second electrode board has four second elongated plate portions, wherein two of the four second elongated plate portions are arranged side by side and are adjacent to the first recess wall, and the first elongated plate portions adjacent to the first recess wall are located between the two second elongated plate portions adjacent to the first recess wall, and the other two of the four second elongated plate portions are arranged side by side and are adjacent to the second recess wall, and the first elongated plate portions adjacent to the second recess wall are located between the two second elongated plate portions adjacent to the second recess wall.

17. The plug connector as claimed in claim 16 further comprising two first signal terminals connected integrally with the second ring and being respectively adjacent to the first recess wall and the second recess wall, wherein the first signal terminal adjacent to the first recess wall is located between the two first elongated plate portions adjacent to the first recess wall, and the first signal terminal adjacent to the second recess wall is located between the two first elongated plate portions adjacent to the second recess wall.

18. The plug connector as claimed in claim 16 further comprising a signal board having two second signal terminals, a third ring, and a third solder pad integrally formed from a front end to a rear end of the signal board, wherein
the two second signal terminals are disposed laterally in the insertion recess and are adjacent respectively to the first recess wall and the second recess wall, the second signal terminal adjacent to the first recess wall is located between the two first elongated plate portions adjacent to the first recess wall, and the second signal terminal adjacent to the second recess wall is located between the two first elongated plate portions adjacent to the second recess wall;
the third ring is secured longitudinally in the insulation base; and
the third solder pad is exposed from the insertion recess.

19. The plug connector as claimed in claim 18, wherein the insulation base comprises
a base body, wherein the third ring and the first ring are arranged in the base body of the insulation from an inner side to an outer side, and the second ring is mounted around the base body; and
an insertion casing being located in front of the base body, and the insertion recess defined in the insertion casing.

20. The plug connector as claimed in claim 19 further comprising a metal housing having a front opening and a rear opening, wherein the front opening communicates with a mouth of the insertion recess in the insertion casing, and the base body is held in the rear opening, wherein a rear portion of the metal housing is located between the base body and the second ring, and wherein the first solder pad, the second solder pad, and the third solder pad extend out of the rear end of the insulation base, and are soldered respectively with metal electrode wires of a charging wire.

21. The plug connector as claimed in claim 20 further comprising an outer rubber body coated around the rear portion of the metal housing and a connection between the second ring and the charging wire, wherein multiple ribs protrude forward from the second ring and extend into the outer rubber body.

22. The plug connector as claimed in claim 1, wherein the first electrode board and the second electrode board are made of metal boards.

23. The plug connector as claimed in claim 1, wherein the first electrode board is a positive board, and the second electrode board is a negative board.
